(19) United States
(12) Patent Application Publication
(10) Pub. No.: US 2026/0280432 A1
(43) Pub. Date: Sep. 17, 2026

(54) SWITCHING REGULATOR

(71) Applicant: ABLIC Inc., Nagano (JP)

(72) Inventor: Kaoru SAKAGUCHI, Nagano (JP)

(73) Assignee: ABLIC Inc., Nagano (JP)

(21) Appl. No.: 19/537,487

(22) Filed: Feb. 12, 2026

(30) Foreign Application Priority Data
Mar. 11, 2025 (JP) 2025-037988

(51) Int. Cl. H02M 3/158

(52) U.S. Cl. CPC H02M 3/1588

(57) ABSTRACT

The switching regulator includes a voltage regulator configured to supply an internal power supply voltage to a switching control circuit, a depletion type first transistor having a drain connected to an output terminal, a second transistor having a drain connected to a source of the first transistor and a source connected to the voltage regulator, and a comparison circuit comparing a source voltage of the first transistor with an output voltage of the voltage regulator. In response to detecting that the source voltage of the first transistor has become higher than the internal power supply voltage, control is performed so that the second transistor is turned on.

### CROSS-REFERENCE TO RELATED APPLICATION

This application claims the priority benefit of Japanese application serial no. 2025-037988, filed on Mar. 11, 2025. The entirety of the above-mentioned patent application is hereby incorporated by reference herein and made a part of this specification.

### BACKGROUND

### Technical Field

The present invention relates to a switching regulator.

### Description of Related Art

As one type of DC/DC converter, there is a type that includes a switching transistor and outputs a predetermined DC voltage by reducing the external power supply voltage by turning this switching transistor on and off. For example, a DC/DC converter is known that can incorporate a switching control circuit in a semiconductor integrated circuit of a normal low-withstand-voltage manufacturing process even when the DC output setting voltage is set high (Patent Document 1, Japanese Patent Application Laid-Open Publication No. 2006-20434). The DC/DC converter described in Patent Document 1 is equipped with a self-bias function that supplies an internal power supply voltage from the output voltage.

However, in response to the output voltage being high and a high-voltage transistor being required, it is necessary to use multiple high-voltage transistors in the circuit for the conventional self-bias function. Thus, there has been a problem that the area of the switching regulator is large.

An object of one embodiment of the present invention is to realize a high-efficiency switching regulator equipped with a self-bias function in a small area even when the output voltage is a high voltage.

### SUMMARY

A switching regulator according to one embodiment of the present invention is a switching regulator that controls an output voltage of an output terminal to a predetermined voltage, the switching regulator includes: a voltage regulator configured to supply an internal power supply voltage to a switching control circuit, a depletion type first transistor having a drain connected to the output terminal, a second transistor having a drain connected to a source of the first transistor and a source connected to an output terminal of the voltage regulator, and a comparison circuit comparing a source voltage of the first transistor with the internal power supply voltage. The comparison circuit controls a gate of the second transistor such that in response to detecting that a source voltage of the first transistor is lower than the internal power supply voltage, the second transistor is turned off, and in response to detecting that a source voltage of the first transistor has become higher than the internal power supply voltage, the second transistor is turned on.

### BRIEF DESCRIPTION OF THE DRAWINGS

FIG. 1 is a diagram illustrating a switching regulator according to a first embodiment of the present invention.

FIG. 2 is a diagram illustrating a switching regulator according to a second embodiment of the present invention.

FIG. 3 is a diagram illustrating a switching regulator according to a first modification example of the second embodiment of the present invention.

FIG. 4 is a diagram illustrating a switching regulator according to a second modification example of the second embodiment of the present invention.

FIG. 5 is a diagram illustrating a switching regulator according to a third embodiment of the present invention.

### DESCRIPTION OF THE EMBODIMENTS

According to one embodiment of the present invention, a high-efficiency switching regulator equipped with a self-bias function may be realized in a small area even in response to the output voltage being a high voltage.

### First Embodiment

Hereinafter, embodiments of the present invention will be described in detail with reference to the drawings.

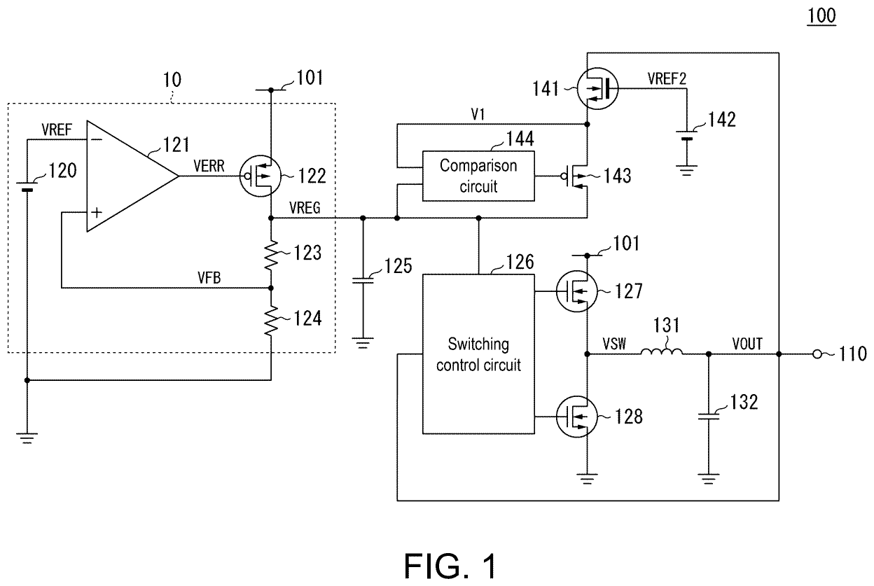

FIG. 1 is a diagram illustrating a switching regulator according to a first embodiment of the present invention. A switching regulator 100 according to the present embodiment receives an external power supply voltage, steps down the external power supply voltage, and outputs an output voltage VOUT from an output terminal 110. A load (not shown) is connected to the output voltage VOUT, and power is supplied from the switching regulator 100. Accordingly, the switching regulator 100 controls the output voltage VOUT of the output terminal 110 to a predetermined voltage.

The switching regulator 100 includes an output terminal 110, a voltage regulator 10, a capacitor 125, a switching control circuit 126, a high-side FET 127, and a low-side FET 128. Furthermore, the switching regulator 100 includes an inductor 131, a capacitor 132, a depletion type transistor 141, a second reference voltage source 142, a PMOS transistor 143, and a comparison circuit 144.

It is noted that the output terminal 110 is an example of an output terminal. The switching control circuit 126 is an example of a switching control circuit. The voltage regulator 10 is an example of a voltage regulator. The depletion type transistor 141 is an example of a first transistor. The PMOS transistor 143 is an example of a second transistor. The comparison circuit 144 is an example of a comparison circuit.

The output transistor 122, the high-side FET 127, the low-side FET 128, and the depletion type transistor 141 are each high-voltage transistors. The PMOS transistor 143 does not need to be a high-voltage transistor.

The voltage regulator 10 supplies an internal power supply voltage VREG to the switching control circuit 126. The voltage regulator 10 includes a first reference voltage source 120, an error amplifier circuit 121, a voltage dividing resistor 123, and a voltage dividing resistor 124.

The first reference voltage source 120 has a first terminal and a second terminal that generates a voltage higher than the voltage of the first terminal by a reference voltage VREF. The first terminal is grounded. The second terminal is connected to an inverting input terminal (−) of the error amplifier circuit 121. Accordingly, the first reference voltage source 120 supplies the reference voltage VREF from the second terminal to the inverting input terminal (−) of the error amplifier circuit 121.

The first reference voltage source 120 is connected to the inverting input terminal (−) of the error amplifier circuit 121. The drain of the output transistor 122 is connected to the non-inverting input terminal (+) of the error amplifier circuit 121 via the voltage dividing resistor 123. The output terminal of the error amplifier circuit 121 is connected to the gate of the output transistor 122.

The output transistor 122 is a P-type MOS transistor. The output terminal of the error amplifier circuit 121 is connected to the gate of the output transistor 122. An external power supply voltage is supplied from the external power supply voltage supply path 101 to the source of the output transistor 122. The non-inverting input terminal (+) of the error amplifier circuit 121 and the power supply terminal of the switching control circuit 126 are connected to the drain of the output transistor 122.

The voltage dividing resistor 123 is provided between the drain of the output transistor 122 and the non-inverting input terminal (+) of the error amplifier circuit 121. One end of the voltage dividing resistor 123 is connected to the drain of the output transistor 122, and the other end is connected to the voltage dividing resistor 124. One end of the voltage dividing resistor 124 is connected to the voltage dividing resistor 123, and the other end is connected to the first terminal of the first reference voltage source 120 and to ground. The non-inverting input terminal (+) of the error amplifier circuit 121 is connected between the voltage dividing resistor 123 and the voltage dividing resistor 124.

The error amplifier circuit 121 controls the gate voltage VERR of the output transistor 122 so that the reference voltage VREF and the feedback voltage VFB match. As a result, the voltage regulator 10 is controlled so that the internal power supply voltage VREG becomes a desired value.

The capacitor 125 includes a first terminal (lower side in FIG. 1) and a second terminal (upper side in FIG. 1). The second terminal of the capacitor 125 is connected to the drain of the output transistor 122 and to the input terminal of the switching control circuit 126. The first terminal of the capacitor 125 is grounded. The capacitor 125 stabilizes the internal power supply voltage VREG.

The internal power supply voltage VREG output from the voltage regulator 10 is supplied to the switching control circuit 126 as the power supply voltage of the switching control circuit 126. In response to the internal power supply voltage VREG changing, the switching control circuit 126 is unable to output a stable output voltage VOUT.

The switching control circuit 126 controls the on and off of the high-side FET 127 and the low-side FET 128, respectively, so that the output voltage VOUT output from the output terminal 110 becomes a predetermined value. The switching control circuit 126 intermittently passes the external power supply voltage from the external power supply voltage supply path 101 through the on and off control to generate the switch terminal voltage VSW. The high-side FET 127 and the low-side FET 128 are N-type MOS transistors.

The high-side FET 127 has a drain supplied with the external power supply voltage from the external power supply voltage supply path 101, a gate connected to one output terminal of the switching control circuit 126, and a source connected to the output terminal 110 and the drain of the low-side FET 128. The low-side FET 128 has a gate connected to the other output terminal of the switching control circuit 126, a drain connected to the source of the high-side FET 127 and the output terminal 110, and a source grounded.

The inductor 131 and the capacitor 132 smooth the switch terminal voltage VSW. The smoothed switch terminal voltage VSW is output from the output terminal 110 as the output voltage VOUT. The inductor 131 is provided between the connection point of the high-side FET 127 and the low-side FET 128 and the output terminal 110. The capacitor 132 includes a first terminal (lower side in FIG. 1) and a second terminal (upper side in FIG. 1). The second terminal of the capacitor 132 is connected between the inductor 131 and the output terminal 110. The first terminal of the capacitor 132 is grounded.

The depletion type transistor 141 is an N-type MOS transistor. The depletion type transistor 141 has a drain connected to the output terminal 110, a gate connected to the second reference voltage source 142, and a source connected to the drain of the PMOS transistor 143.

The second reference voltage source 142 has a first terminal and a second terminal that generates a voltage higher than the voltage of the first terminal by a second reference voltage VREF2. The first terminal is grounded. The second terminal is connected to the gate of the depletion type transistor 141. Accordingly, the second reference voltage source 142 supplies the second reference voltage VREF2 from the second terminal to the gate of the depletion type transistor 141.

The PMOS transistor 143 is a P-type MOS transistor. The PMOS transistor 143 has a drain connected to the source of the depletion type transistor 141, a gate connected to the output terminal of the comparison circuit 144, and a source connected to the output terminal of the voltage regulator 10 (that is, the drain of the output transistor 122). In addition, the power supply terminal of the switching control circuit 126 is connected to the source of the PMOS transistor 143 and the drain of the output transistor 122.

The source of the depletion type transistor 141 and the output terminal of the voltage regulator 10 are respectively connected to the input terminal of the comparison circuit 144. The output terminal of the comparison circuit 144 is connected to the gate of the PMOS transistor 143. The comparison circuit 144 compares the source voltage V1 of the depletion type transistor 141 with the output voltage of the voltage regulator 10 (that is, the internal power supply voltage VREG).

In response to detecting that the source voltage V1 of the depletion type transistor 141 is lower than the internal power supply voltage VREG of the voltage regulator 10, the comparison circuit 144 controls the gate of the PMOS transistor 143 so that the PMOS transistor 143 turns off. On the other hand, in response to detecting that the source voltage V1 of the depletion type transistor 141 has become higher than the output voltage of the voltage regulator 10, the comparison circuit 144 controls the gate of the PMOS transistor 143 so that the PMOS transistor 143 turns on. That is, in response to detecting that the source voltage V1 of the depletion type transistor 141 has become higher than the internal power supply voltage VREG, the comparison circuit 144 controls the gate of the PMOS transistor 143 so that the PMOS transistor 143 turns on.

In response to the output voltage VOUT being low, the source voltage V1 of the depletion type transistor 141 is lower than the internal power supply voltage VREG supplied from the output transistor 122 of the voltage regulator 10. In response to this, the comparison circuit 144 keeps the PMOS transistor 143 off. In the case of the PMOS transistor 143 being off, the internal power supply voltage VREG is supplied from the output transistor 122 to the switching control circuit 126.

In the case of the output voltage VOUT rising and the source voltage V1 exceeding the internal power supply voltage VREG supplied from the output transistor 122, the comparison circuit 144 turns on the PMOS transistor 143. In the case of the PMOS transistor 143 being on, the internal power supply voltage VREG is supplied to the switching control circuit 126 from the output voltage VOUT through the depletion type transistor 141 and the PMOS transistor 143. That is, in the case of the output voltage VOUT being higher than the internal power supply voltage VREG, the self-bias function operates such that the internal power supply voltage VREG is supplied from the output voltage VOUT.

The self-bias function operates to supply power to the switching control circuit 126, which consumes a large current, from the output voltage VOUT lower than the external power supply voltage through the depletion type transistor 141 and the PMOS transistor 143, thereby suppressing power consumption and achieving high efficiency.

Since the depletion type transistor 141 is a depletion type, it may be turned on even in the case of the gate voltage being low. In the case of including an enhancement type transistor instead of the depletion type transistor 141, it is necessary to supply a high gate voltage to the gate of the transistor so as to turn on the transistor. In order to supply a high-voltage gate voltage, a boost circuit or the like is necessary in addition to the second reference voltage source 142, and a high-voltage transistor is further necessary to configure the boost circuit. Since it is sufficient for the switching regulator 100 to include one depletion type transistor 141, even in the case of the output voltage VOUT being a high voltage, the number of elements of the circuit that performs switching of the internal power supply may be reduced, and the area of the circuit may be made small.

In the case of the output voltage VOUT being low, in order to cause the internal power supply voltage VREG to be supplied from the output transistor 122, it is necessary to prevent backflow in the self-bias path. The backflow in the self-bias path is that current is supplied to the output terminal 110 from the internal power supply voltage VREG through the depletion type transistor 141, thereby increasing the output voltage VOUT. In order to prevent backflow in the self-bias path, it is necessary to block the path through the depletion type transistor 141.

Thus, the switching regulator 100 includes the PMOS transistor 143 and the comparison circuit 144. Accordingly, in response to the output voltage VOUT being low, that is, in response to the internal power supply voltage VREG being supplied from the output transistor 122, the PMOS transistor 143 is turned off to block the self-bias path through the depletion type transistor 141. The switching regulator 100 may appropriately switch the internal power supply according to the output voltage VOUT while preventing backflow in the self-bias path.

As described above, according to the switching regulator 100, which is an example of the switching regulator according to the present embodiment, even in the case of the output voltage VOUT being a high voltage, a high-efficiency switching regulator including a self-bias function may be realized in a small area.

### Second Embodiment

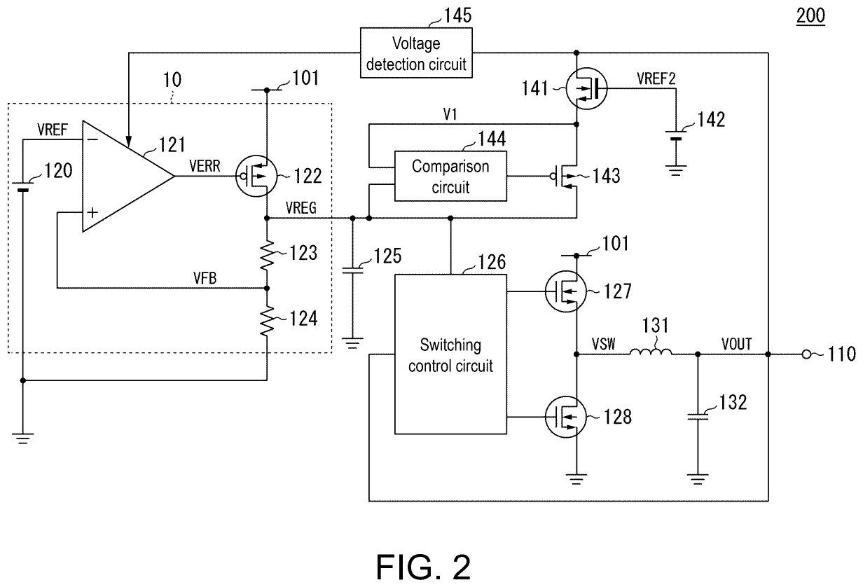

FIG. 2 is a diagram illustrating a switching regulator according to a second embodiment of the present invention. Comparing the switching regulator 200 (FIG. 2) according to the present embodiment with the switching regulator 100 (FIG. 1) according to the first embodiment, the voltage detection circuit 145 differs.

It is noted that the voltage detection circuit 145 is an example of a voltage detection circuit.

Here, the functions of other components are the same as those in the first embodiment. The same reference numerals are assigned to the same configurations as those in the first embodiment, and descriptions of the same configurations and operations may be omitted.

The drain of the depletion type transistor 141 and the output terminal 110 are connected to an input terminal of the voltage detection circuit 145. An output terminal of the voltage detection circuit 145 is connected to the error amplifier circuit 121 and controls the operation of the error amplifier circuit 121. In response to detecting that the output voltage VOUT has become higher than a predetermined voltage, the voltage detection circuit 145 controls the output transistor 122 to turn off by stopping the operation of the error amplifier circuit 121. That is, in response to detecting that the output voltage VOUT has become higher than a predetermined voltage, the voltage detection circuit 145 turns off the operation of the voltage regulator 10.

In response to the output transistor 122 stopping, the internal power supply voltage VREG decreases. In response to the decrease in the internal power supply voltage VREG, the comparison circuit 144 detects that the source voltage V1 has become higher than the output voltage VOUT at a lower output voltage VOUT. Thus, the setting range of the output voltage VOUT for supplying the internal power supply voltage VREG from the output voltage VOUT may be widened. By stopping the error amplifier circuit 121, the switching regulator 200 may achieve low current consumption even in the case where the output voltage VOUT is high and may increase efficiency compared to the switching regulator 100.

The predetermined voltage for the voltage detection circuit 145 to detect that the output voltage VOUT has become higher than the predetermined voltage so as to turn off the output transistor 122 may be set to a value lower than the output voltage VOUT by a predetermined value. However, in the case where a value that is too low is set as the predetermined voltage, the range in which the error amplifier circuit 121 is turned off by the voltage detection circuit 145 becomes wide, and the voltage regulator 10 becomes substantially unable to operate. Thus, the predetermined voltage is set within a range in which the voltage regulator 10 may operate.

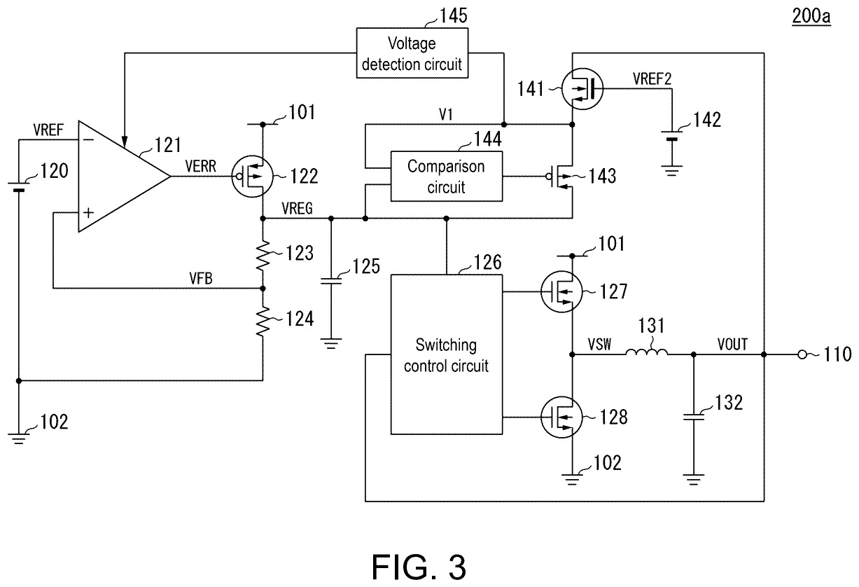

FIG. 3 is a diagram illustrating a switching regulator according to a first modification example of the second embodiment of the present invention. In the switching regulator 200a according to this modification example, the source of the depletion type transistor 141 is connected to an input terminal of the voltage detection circuit 145. Thus, the source voltage V1 is received by the voltage detection circuit 145 instead of the output voltage VOUT. In response to detecting that the source voltage V1 has become higher than a predetermined voltage, the voltage detection circuit 145 controls the output transistor 122 to turn off by stopping the operation of the error amplifier circuit 121. Since the source voltage V1 becomes higher according to the output voltage VOUT, in the switching regulator 200a, the voltage detection circuit 145 detects that the output voltage VOUT has become higher than a predetermined voltage through the source voltage V1.

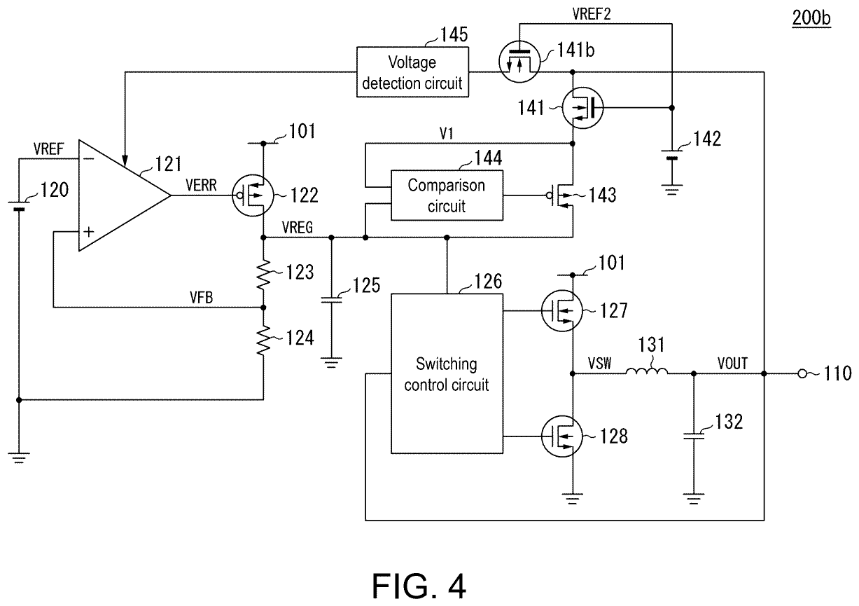

FIG. 4 is a diagram illustrating a switching regulator according to a second modification example of the second embodiment of the present invention. Comparing the switching regulator 200b (FIG. 4) according to this modification example with the switching regulator 100 (FIG. 1) according to the first embodiment, the depletion type transistor 141b is different. It is noted that the depletion type transistor 141b is an example of a third transistor.

The depletion type transistor 141b is an N-type MOS transistor. In the depletion type transistor 141b, the output terminal 110 is connected to the drain, an input terminal of the voltage detection circuit 145 is connected to the source, and the second reference voltage source 142 is connected to the gate. Thus, the drain of the depletion type transistor 141b and the drain of the depletion type transistor 141 are connected in parallel to the output terminal 110. The gate of the depletion type transistor 141b and the gate of the depletion type transistor 141 are connected to the second reference voltage source 142.

In the switching regulator 200b, the number of depletion type transistors is increased by one compared to the configuration of the switching regulator 200 or the switching regulator 200a described above. However, the number of depletion type transistors included in the entire circuit is at most two. According to the configuration of the switching regulator 200b, even in the case where the output voltage VOUT is a high voltage, the number of elements in the circuit that performs switching of the internal power supply may be reduced, and the area of the circuit may be reduced.

### Third Embodiment

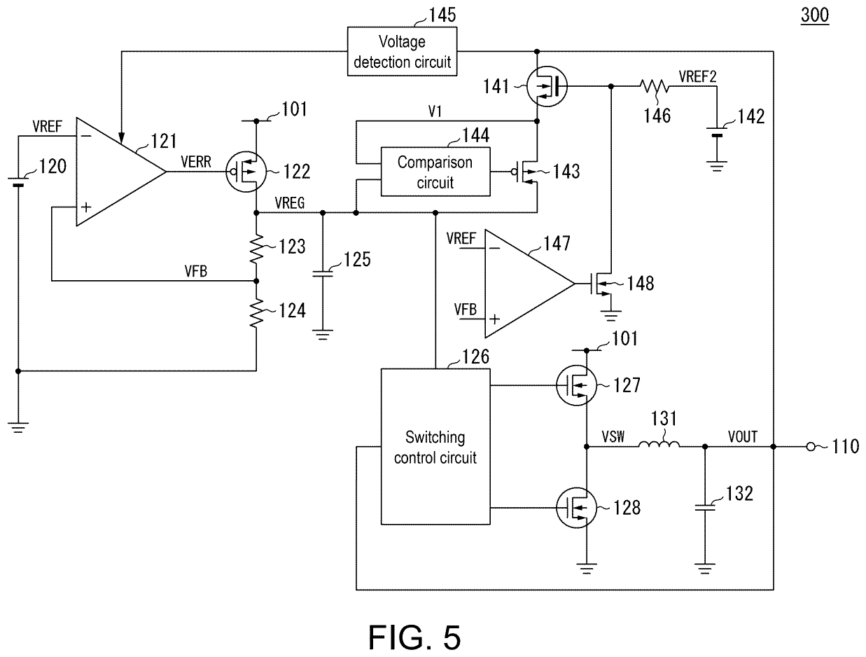

FIG. 5 is a diagram illustrating a switching regulator according to a third embodiment of the present invention. Comparing the switching regulator 300 (FIG. 5) according to the present embodiment with the switching regulator 200 (FIG. 2) according to the second embodiment, a resistor 146, an error amplifier circuit 147, and an NMOS transistor 148 differ.

It is noted that the error amplifier circuit 147 is an example of an error amplifier circuit. The NMOS transistor 148 is an example of a fourth transistor.

A gate of the depletion type transistor 141 is connected to the second reference voltage source 142 via a resistor 146.

A second terminal of the first reference voltage source 120 is connected to an inverting input terminal (−) of the error amplifier circuit 147. Accordingly, the inverting input terminal (−) of the error amplifier circuit 147 and the inverting input terminal (−) of the error amplifier circuit 121 are connected to the second terminal of the first reference voltage source 120. The drain of the output transistor 122 is connected to the non-inverting input terminal (+) of the error amplifier circuit 147 via the voltage dividing resistor 123. Accordingly, the non-inverting input terminal (+) of the error amplifier circuit 147 and the non-inverting input terminal (+) of the error amplifier circuit 121 are connected to the drain of the output transistor 122 via the voltage dividing resistor 123.

It is noted that in FIG. 5, wiring to each of the non-inverting input terminal (+) and the inverting input terminal (−) of the error amplifier circuit 147 is omitted. An output terminal of the error amplifier circuit 147 is connected to a gate of the NMOS transistor 148.

The NMOS transistor 148 has a drain connected to a gate of the depletion type transistor 141, a gate connected to an output terminal of the error amplifier circuit 147, and a source grounded.

The error amplifier circuit 147 controls the gate of the NMOS transistor 148 in response to a change in the internal power supply voltage VREG in response to the comparison circuit 144 detecting that the source voltage of the depletion type transistor 141 has become higher than the internal power supply voltage VREG. Accordingly, the error amplifier circuit 147 controls the internal power supply voltage VREG to become a predetermined value in a case where voltage is supplied to the switching control circuit 126 from the output voltage VOUT via the depletion type transistor 141 and the PMOS transistor 143. In other words, the gate of the depletion type transistor 141 is feedback controlled by the error amplifier circuit 147 that detects a change in the internal power supply voltage of the voltage regulator so that the reference voltage VREF and the feedback voltage VFB match.

Here, the internal power supply voltage VREG in response to the self-bias path becoming effective may have variations due to variations in the threshold voltage of the depletion type transistor 141 and the second reference voltage VREF2. In the switching regulator 300, the above feedback control of the error amplifier circuit 147 may suppress variations in the internal power supply voltage VREG in response to the self-bias path being effective and may stabilize the output voltage VOUT.

In each embodiment, an example in which the depletion type transistor 141 is an N-type MOS transistor has been described, but the present invention is not limited thereto. The depletion type transistor 141 may be a P-type MOS transistor.

These embodiments and modifications thereof are included in the scope and gist of the present invention and are included in the invention described in the claims and the equivalent scope thereof.

What is claimed is:

1. A switching regulator that controls an output voltage of an output terminal to a predetermined voltage, the switching regulator comprising:
a voltage regulator, configured to supply an internal power supply voltage to a switching control circuit;
a depletion type first transistor, having a drain connected to the output terminal;
a second transistor, having a drain connected to a source of the first transistor and a source connected to an output terminal of the voltage regulator; and
a comparison circuit, comparing a source voltage of the first transistor with the internal power supply voltage,
wherein the comparison circuit controls a gate of the second transistor such that in response to detecting that a source voltage of the first transistor is lower than the internal power supply voltage, the second transistor is turned off, and in response to detecting that a source voltage of the first transistor has become higher than the internal power supply voltage, the second transistor is turned on.

2. The switching regulator according to claim 1, further comprising a voltage detection circuit that turns off an operation of the voltage regulator in response to detecting that the output voltage has become higher than a predetermined voltage.

3. The switching regulator according to claim 2, wherein the output terminal is connected to an input terminal of the voltage detection circuit.

4. The switching regulator according to claim 2, further comprising a depletion type third transistor having a drain connected to the output terminal and a source connected to an input terminal of the voltage detection circuit.

5. The switching regulator according to claim 1, further comprising:
an error amplifier circuit, configured to detect a change in the internal power supply voltage; and
a fourth transistor, having a gate connected to an output terminal of the error amplifier circuit and a drain connected to a gate of the first transistor,
wherein in response to the comparison circuit detecting that a source voltage of the first transistor has become higher than the internal power supply voltage,
the error amplifier circuit controls a gate of the fourth transistor in response to a change in the internal power supply voltage.
